(19) United States
(12) Patent Application Publication
(10) Pub. No.: US 2009/0162676 A1
(43) Pub. Date: Jun. 25, 2009

(54) Overmolded Plastic Articles, Uses Thereof, Method Of Making

(75) Inventors: Mohammad Jamal El-Hibri, Atlanta, GA (US); Brian A. Stern, Duluth, GA (US)

Correspondence Address: OBLON, SPIVAK, MCCLELLAND MAIER & NEUSTADT, P.C., 1940 DUKE STREET, ALEXANDRIA, VA, 22314, US

(73) Assignee: SOLVAY ADVANCED POLYMERS, L.L.C., Alpharetta, GA (US)

(21) Appl. No.: 11/576,500

(22) PCT Filed: Sep. 30, 2005
(86) PCT No.: PCT/EP2005/054938

§ 371 Date: Oct. 30, 2007

Related U.S. Application Data
(60) Provisional application No. 60/615,023, filed on Oct. 4, 2004.
(60) Provisional application No. 60/619,694, filed on Oct. 19, 2004.

(51) Int. Cl. B32B 15/08; B28B 3/00

(52) U.S. Cl. 428/457; 264/297.2

(57) ABSTRACT

Article (A) comprising at least one metal component (M), said metal component (M) being overmolded with at least one polymer composition (C) comprising at least one high glass transition temperature sulfone polymer (P). Process for producing article (A), which comprises the step of applying polymer composition (C) to a surface of metal component (M).

### REFERENCE TO RELATED APPLICATIONS

This application claims priority to U.S. provisional application 60/615,023, filed Oct. 4, 2004, and to U.S. provisional application 60/619,694, filed Oct. 19, 2004, whose disclosures are incorporated herein by reference.

### FIELD OF THE INVENTION

The present invention relates to plastic articles comprising at least one metal component, said metal component being overmolded with at least one polymer composition including at least one high performance plastic of a specific kind, namely a high glass transition temperature sulfone polymer. Such articles replace advantageously articles of the prior art which include a full metal component. In this regard the invention overmolded articles provide high temperature capability, good retention of modulus at high temperature, long term thermal stability, low loss of mechanical properties over extended time and temperature cycles, and high chemical resistance including hydrolytic stability, chemical resistance to strong acid and bases, and chemical resistance to aliphatic and aromatic hydrocarbons.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Currently, many articles are fabricated as one- or multi-component element systems made of metal. Such devices can be relatively complex, making their fabrication and assembly both costly and time consuming. In addition, generally speaking, such articles are usually heavy.

The inventors investigated the fabrication of single component articles using at least one polymer composition comprising at least one high glass transition temperature sulfone polymer high performance polymers as replacements for such metal-made articles. However, the material costs associated with high glass transition temperature sulfone polymers could not justify such replacement. This is usually true notably when multi-component articles become sufficiently large that the material and processing costs to produce a single component replacement system out of the high glass transition temperature sulfone polymer, for example to be used as a “drop-in” replacement article, become more expensive than fabricating the multi-component article itself. “Drop-in” replacement refers to removing a currently utilized multi-component article and replacing it with a present invention overmolded article without need for special modification or alterations.

US Patent Application Number 2002/0025241 discloses a part mounting bolt for use in applications such as mounting a headlight, a fog lamp, a bicycle lamp, mirrors and the like onto an existing mounted member such as a car bumper or a base plate. The mounting bolt has a gear which facilitates fine adjustments of, for example, a headlight after being mounted to the mounted member. The gear is injection molded onto the bolt body in a die. The resins disclosed are various types of nylons, polyamide-imide and polyacetals.

### DETAILED DESCRIPTION OF THE PREFERRED EMBODIMENTS

The present invention provides a low cost, high performance overmolded plastic article. The article according to the present invention is an article (A) comprising at least one metal component (M), said metal component (M) being overmolded with at least one polymer composition (C) comprising at least one high glass transition temperature sulfone polymer (P).

Metal component (M) can be overmolded notably by the overcoating technique.

The overmolding may be partial or complete (i.e., varying from greater than zero to 100% overcoated).

The metal of metal component (M) is advantageously chosen from steel, iron, titanium, copper, tin, aluminum, gold, silver, and mixtures thereof such as bronze.

The shape of overall article (A), and the shape of metal component (M), is not limited.

Preferably, metal component (M) is less expensive than polymer composition (C). Metal components may be self supporting, non-self-supporting, solid, perforated, honeycomb, etc. In a preferred embodiment, metal component (M) is approximately the same shape and dimension as the final product. More than one metal component (M) can be present in one invention overmolded article (A).

The external surface of polymer composition (C) overmold may have any feature, shape, size, etc., necessary to its function, regardless of the shape and size of underlying metal component (M). Thus, the present invention allows for, among other things, the “drop-in” replacement of a multi-component with an overmolded high performance plastic article which appears to be, and in essence is from a functional perspective, a single component, satisfying both performance and cost requirements.

The present invention also provides a method of manufacturing article (A).

Overmolding can provide an article (A) such that little, some, most, or all, of metal component (M) is in contact with the high performance plastic. In this invention the term “overmolding” simply describes the location of polymer composition (C) in contacting relation to the underlying metal component (M), and does not denote a particular process for producing article (A), or the amount of polymer composition (C) that is in contacting relation with metal component (M). Article (A) thus comprises, in a broad sense, at least one metal component (M) and, thereon and in contact therewith, at least one polymer composition (C). In many applications not all areas of metal component (M) need be covered by polymer composition (C).

### Detailed Description of Polymer (P)

For the purpose of the invention, the term “polymer” is intended to denote any material consisting essentially of recurring units, and having a molecular weight above 2000.

For the purpose of the invention, the term “high glass transition temperature sulfone polymer” [polymer (P)] is intended to denote any polymer, of which more than 50 wt. of the recurring units are recurring units (R1):

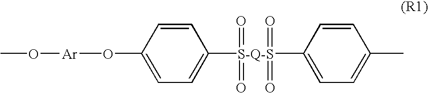

wherein Ar and Q, equal or different, are divalent radicals comprising at least aromatic ring.

Preferred recurring units (R1) are those wherein Q is a group chosen among the following structures:

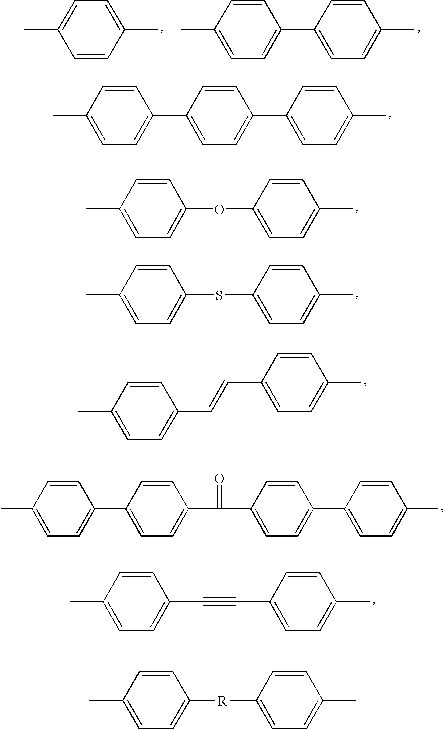

with R being:

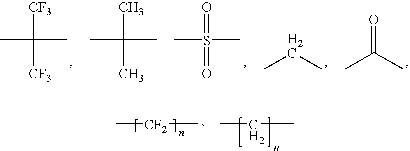

with n=integer from 1 to 6, or an aliphatic divalent group, linear or branched, of up to 6 carbon atoms;
and mixtures thereof; and

Ar is a group chosen among the following structures:

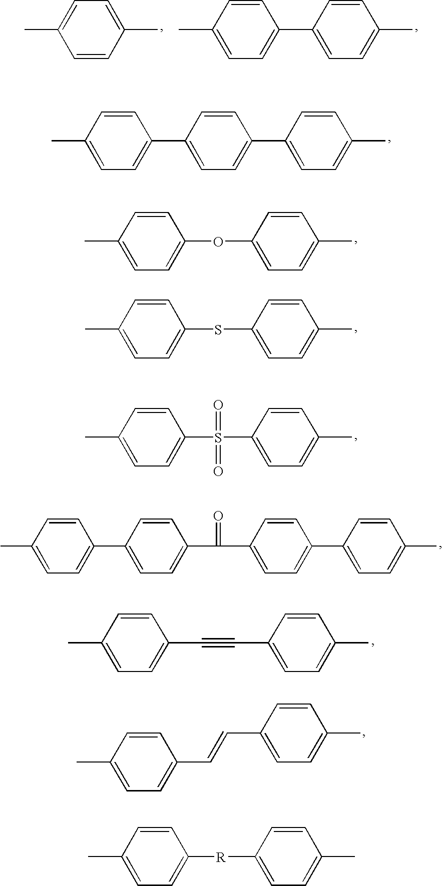

with R being:

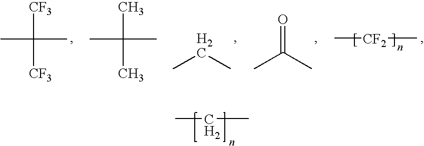

with n=integer from 1 to 6, or an aliphatic divalent group, linear or branched, of up to 6 carbon atoms; and mixtures thereof.

More preferably, recurring units (R1) are chosen from:

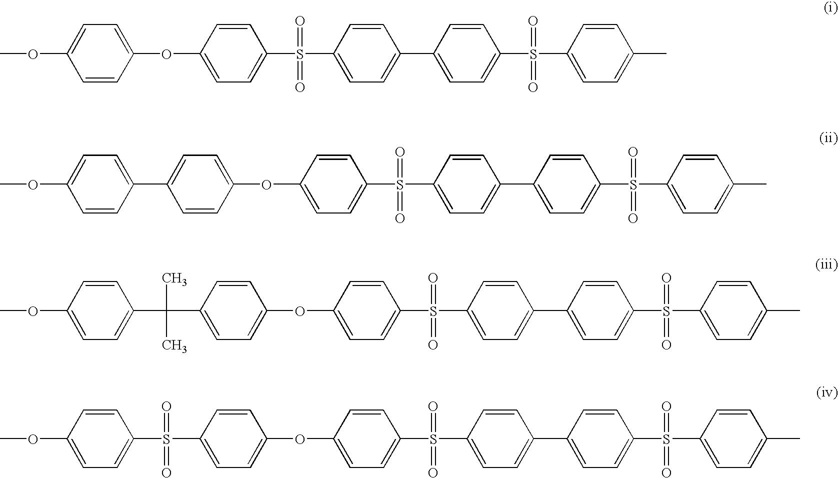

and mixtures therefrom.

Still more preferably, recurring units (R1) are recurring units (ii).

In a particular embodiment of the invention, polymer (P) further comprises recurring units (R2)

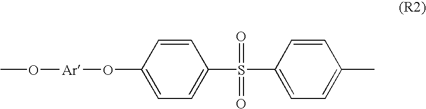

wherein Ar′ is chosen among:

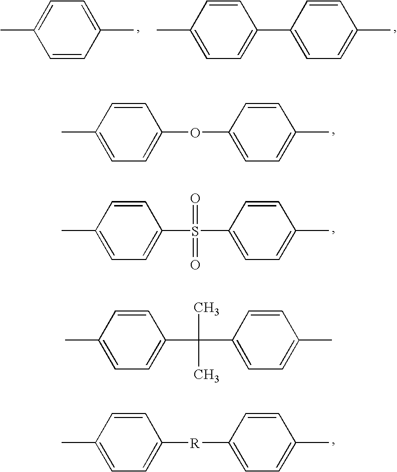

with R being an aliphatic divalent group of up to 6 carbon atoms, such as methylene, ethylene, isopropylene and the like [polymer (P*)].

Recurring units (R2) are preferably chosen from:

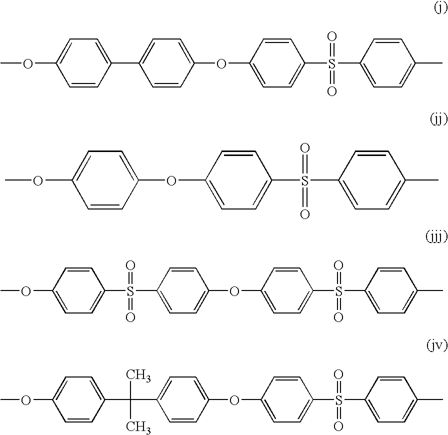

and mixtures thereof.

Polymer (P*) may notably be a random, alternating or block copolymer. Preferably, it is a block copolymer.

Polymer (P) comprises preferably more than 70 wt. %, and more preferably more than 90 wt. % of recurring units (R1). Still more preferably, it contains no recurring unit other than recurring units (R1).

Excellent results are obtained with polymers (P) which are homopolymers the recurring units of which are recurring units (ii).

A polymer the recurring units of which are recurring units (ii) can be advantageously manufactured by the polycondensation reaction between 4,4′-bis[(4-chlorophenylsulfonyl)-1,1′-biphenyl and biphenol.

### Detailed Description of Polymer Composition (C)

Polymer composition (C) can consist of a sole ingredient [the case being, polymer (P)] or of several ones. In addition to polymer (P), polymer composition (C) may further comprise notably other polymers than polymer (P), fillers and conventional ingredients of sulfone polymer compositions such as stabilizers, i.e., metal oxides such as zinc oxide, antioxidants and flame retardants.

Should the polymer composition comprise at least two ingredients, it is advantageously prepared by any conventional mixing method. A preferred method comprises mixing polymer (P) and the optional ingredients in powder or granular form in an extruder and extruding the mixture into strands and chopping the strands into pellets. Said pellets are advantageously molded into the desired electronic component.

Polymer composition (C) has advantageously a glass transition temperature in the range of about 240-275° C.

Polymer composition (C) comprises advantageously more than 25 wt. % of polymer (P).

In a certain embodiment of the present invention, a preferred polymer composition (C) is one comprising more than 50 wt. % of polymer (P) [polymer composition (C*)]. Polymer composition (C*) comprises preferably more than 80 wt. %, more preferably more than 95 wt. % of polymer (P). Still more preferably, polymer composition (C*) consists essentially of, or even consists of, polymer (P).

In another embodiment of the present invention, a preferred polymer composition (C) is one further comprising, in addition to polymer (P), at least one polymer (P2) chosen from polyetherimides, polysulfones, polyethersulfones, polyphenylsulfones, polyetherethersulfones, and copolymers and mixtures thereof [polymer composition (C**)].

For the purpose of the invention, the term “polyetherimide” is intended to denote any polymer, of which more than 50% wt of the recurring units are recurring units (R3), comprising two imide groups as such (R3-A) and/or in their corresponding amic acid forms [(R3-B) and (R3-C)]

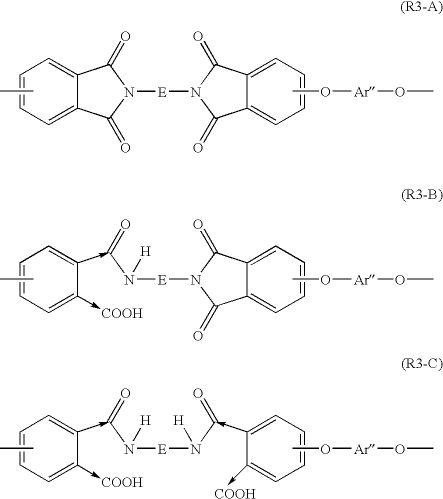

wherein:
the → denotes isomerism so that in any recurring unit the groups to which the arrows point may exist as shown or in an interchanged position;
E is typically:

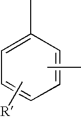

with R′ being a hydrogen atom or an alkyl radical comprising from 1 to 6 carbon atoms;

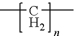

with n=integer from 1 to 6;

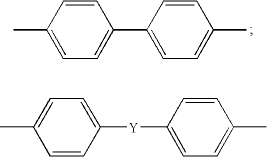

with Y being:

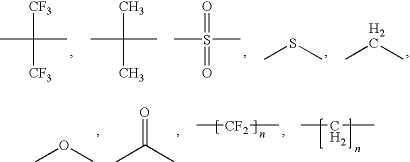

with n=integer from 1 to 6;
Ar″ is typically

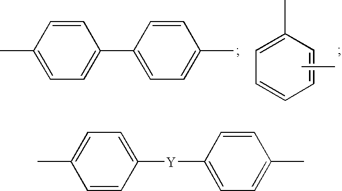

with Y being:

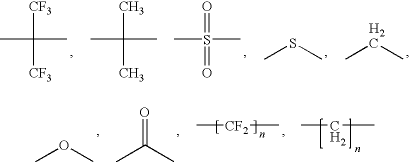

with n=integer from 1 to 6.

Recurring units (R3) are preferably recurring units (k), in imide form (k-A) and/or in amic acid forms [(k-B) and (k-C)]

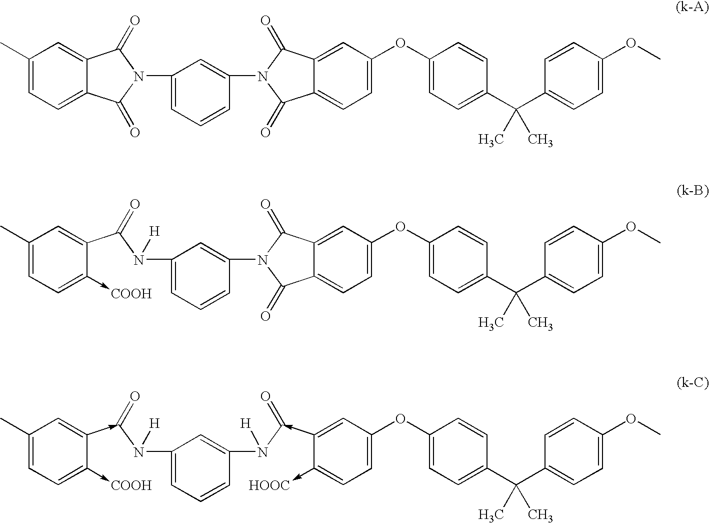

wherein in formulae (k-B) and (k-C) the → denotes isomerism so that in any recurring unit the groups to which the arrows point may exist as shown or in an interchanged position.

For clarity, the structural repeat units of polyphenylsulfone, polysulfone, polyethersulfone, and polyetherethersulfone are listed below:

### Polyphenylsulfone (PPSF)

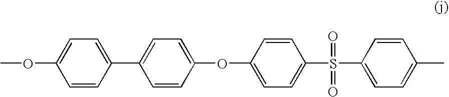

### Polyetherethersulfone (PEES)

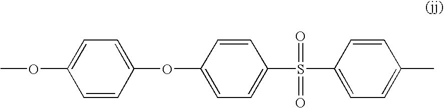

### Polyethersulfone (PES)

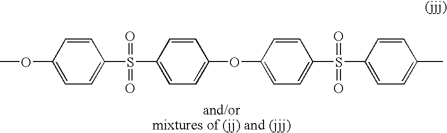

### Polysulfone (PSF)

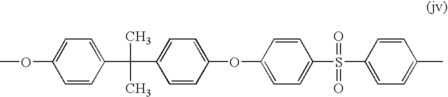

Polyphenylsulfone is available as RADEL® R PPSF from Solvay Advanced Polymers, L.L.C. Polysulfone is available as UDEL® PSF from Solvay Advanced Polymers, L.L.C. Polyethersulfone is available as RADEL® A PES from Solvay Advanced Polymers, L.L.C. Polyetherethersulfone (jj) is the polymer formed from the polycondensation of 4,4′-dihalodiphenylsulfone and hydroquinone.

Polymer composition (C**) comprises preferably polymer (P) as main polymer [i.e., in polymer composition (C**), the weight fraction of polymer (P) is greater than or equal to the weight fraction of polymer (P2)]. More preferably, polymer composition (C**) comprises more than 50 wt. % of polymer (P). Still more preferably, polymer composition (C**) comprises preferably more than 75 wt. % of polymer (P).

Still in another embodiment of the present invention, a preferred polymer composition (C) is one further comprising, in addition to polymer (P), at least one filler [polymer composition (C³*)].

Non limitative examples of suitable fillers include flake, spherical and fibrous particulate reinforcement fillers and nucleating agents such as talc, mica, titanium dioxide, potassium titanate, silica, kaolin, chalk, alumina, mineral fillers, and the like. Other suitable fillers include notably glass fiber, carbon fiber, graphite fiber, fibers formed of silicon carbide, alumina, titania, boron and the like, and may include mixtures comprising two or more such fibers.

Polymer composition (C³*) comprises preferably at least one fibrous filler.

The weight amount of filler comprised in polymer composition (C³*) is advantageously at least 5 wt. %, and preferably at least 20 wt. % based on the total weight of the polymer composition. Besides, it is advantageously at most 40 wt. %, and preferably at most 20 wt. % based on the total weight of the polymer composition.

Polymer composition (C³*) comprises preferably more than 50 wt. % of polymer (P). Still more preferably, polymer composition (C³*) comprises preferably more than 75 wt. % of polymer (P).

Polymer composition (C) is comprised in article (A) in an amount of advantageously at least 10 volume %, preferably at least 20 volume % and still more preferably at least 30 volume %, based on the total volume of the article.

Besides, polymer composition (C) is comprised in article (A) in an amount of advantageously at most 70 volume %, preferably at most 60 volume %, more preferably at most 50 volume % and still more preferably at most 40 volume %, based on the total volume of the article.

Besides, polymer composition (C) is comprised in article (A) in an amount of advantageously at least 5 wt. %, based on the total weight of the article.

Besides, polymer composition (C) is comprised in article (A) in an amount of advantageously at most 30 wt. %, based on the total weight of the article.

The thickness of overmolded polymer composition (C) is not limited, but is preferably from 0.25 to 1.5 mm, including for example 0.3, 0.4, 0.5, 0.6, 0.7, 0.8, 0.9, 1.0, 1.1, 1.2, 1.3, and 1.4 mm. Very preferably, the thickness of overmolded polymer composition (C) is above 0.5 mm. Still more preferably, the thickness of overmolded of polymer composition (C) is above 0.8 mm.

As above detailed, in article (A), metal component (M) can be notably partially overmolded with polymer composition (C). The case being, metal component (M), in addition to be partially overmolded with at least one polymer composition (C), can also be partially overmolded with at least one other composition (C2) comprising at least one high-temperature polymer (P3) different from polymer (P); otherwise said, some surfaces of metal component (M) are overmolded with polymer composition (C) while some other surfaces of metal component (M) are overmolded with polymer composition (C2).

Polymer (P3) is advantageously chosen from, but is not limited to, aromatic polyimides like polyamide-imides (such as TORLON® PAI), polyetherimides and other polyimides (such as VESPEL® and AURUM® PIs); polyamides (PAs) like polyphthalamides, PA 66, PA 46, PA 6, DuPont HTN, Mitsui/FMS PA 6T/6I and PA 6T/66, PMXD6 (such as IXEF®); polyketones (such as polyetheretherketones); polysulfones (such as Udel®), polyethersulfones (such as Radel® A): polyphenylsulfones (such as Radel® R); polyarylenesulfides like polyphenylenesulfides (such as Primef®).

Polymer (P3) is preferably an aromatic polyimide.

To the purpose of the present invention, “aromatic polyimide” is intended to denote any polymer of which more than 50% wt of the recurring units comprise at least one aromatic ring and at least one imide group, as such (formula 1A) or in its amic acid form (formula 1B) [recurring unit (R_{P1})]

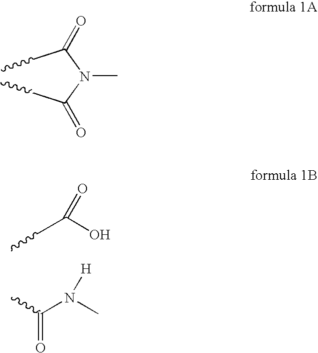

The imide group, as such or in its corresponding amic acid form, is advantageously linked to an aromatic ring, as illustrated below:

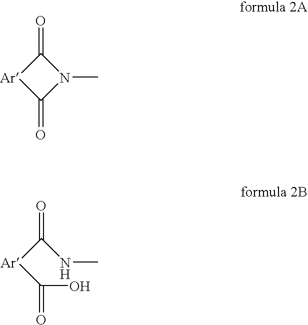

whereas Ar′ denotes a moiety containing at least one aromatic ring.

The imide group is advantageously present as condensed aromatic system, yielding a five- or six-membered heteroaromatic ring, such as, for instance, with benzene (phthalimide-type structure, formula 3) and naphthalene (naphthalimide-type structure, formula 4).

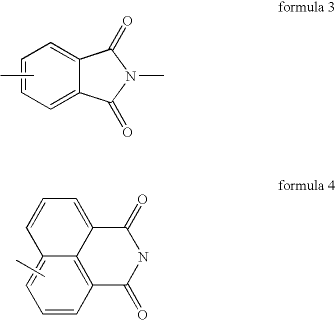

The formulae here below depict examples of recurring unit (R_{P1}) (formulae 5A to 5C):

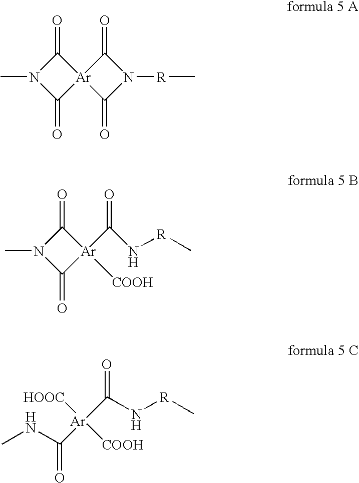

where:

Ar is typically:

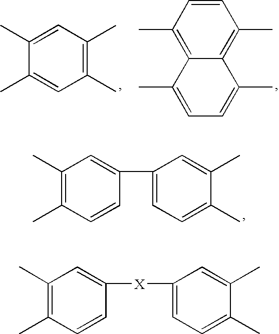

with X=

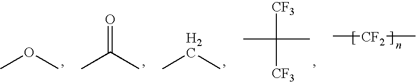

with n=0, 1, 2, 3, 4 or 5;

R is typically:

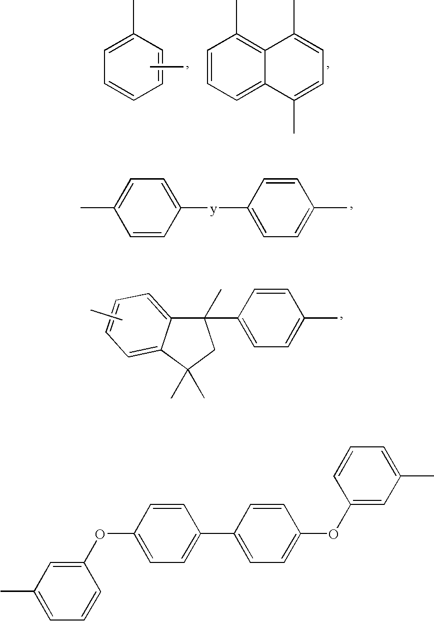

with Y=

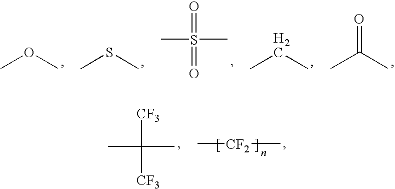

with n=0, 1, 2, 3, 4 or 5.

Polymers commercialized by Du Pont as VESPEL® polyimides or by Mitsui as AURUM®V polyimides are suitable for the invention.

The recurring units of the aromatic polyimide can comprise one or more functional groups other than the imide group, as such and/or in its amic acid form. Non limitative examples of polymers complying with this criterion are aromatic polyetherimides, aromatic polyesterimides and aromatic polyamide-imides.

Polymer (P3) is more preferably an aromatic polyimide chosen from aromatic polyamide-imides and aromatic polyesterimides. Still more preferably, polymer (P3) is an aromatic polyamide-imide.

To the purpose of the present invention, “aromatic polyesterimide” is intended to denote any polymer more than 50 wt. % of the recurring units comprise at least one aromatic ring, at least one imide group, as such and/or in its amic acid form, and at least one ester group. Typically, aromatic polyesterimides are made by reacting at least one acid monomer chosen from trimellitic anhydride and trimellitic anhydride monoacid halides with at least one diol, followed by reaction with at lest one diamine.

To the purpose of the present invention, “aromatic polyamide-imide” is intended to denote any polymer comprising more than 50% wt of recurring units comprising at least one aromatic ring, at least one imide group, as such and/or in its amic acid form, and at least one amide group which is not included in the amic acid form of an imide group [recurring units (R4)].

The recurring units (R4) are advantageously:

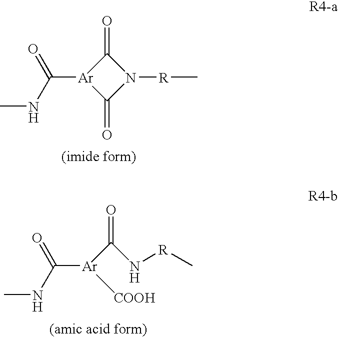

where:

Ar is typically:

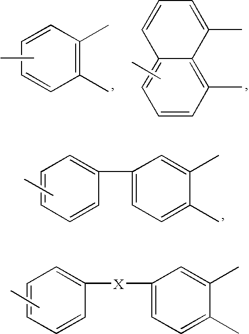

with X=

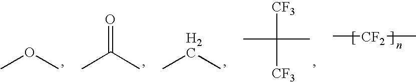

with n=0, 1, 2, 3, 4 or 5;

R is typically:

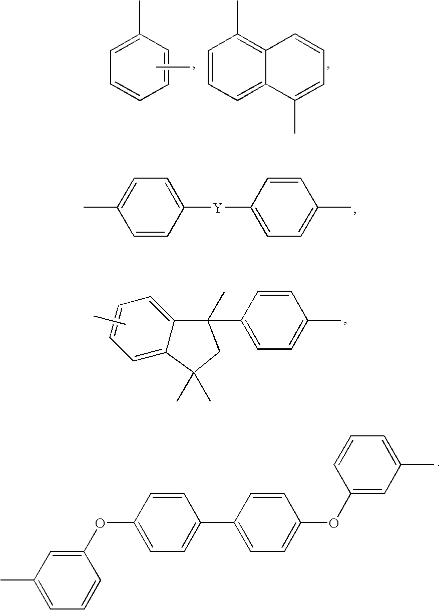

with Y=

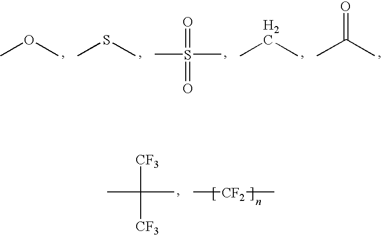

with n=0, 1, 2, 3, 4 or 5.

Preferably, the aromatic polyamide-imide comprises more than 50% of recurring units (R4) comprising an imide group in which the imide group is present as such, like in recurring units (R4-a), and/or in its amic acid form, like in recurring units (R4-b).

Recurring units (R4) are preferably chosen from:

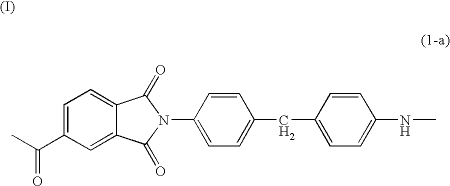

and/or the corresponding amide-amic acid containing recurring unit:

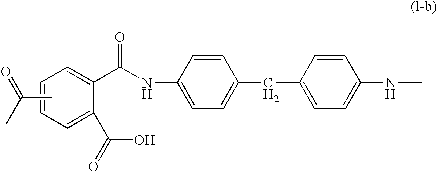

wherein the attachment of the two amide groups to the aromatic ring as shown in (1-b) will be understood to represent the 1,3 and the 1,4 polyamide-amic acid configurations;

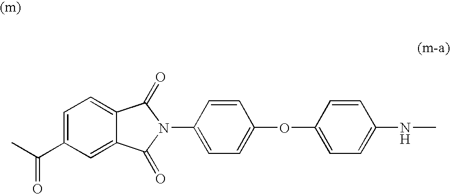

and/or the corresponding amide-amic acid containing recurring unit:

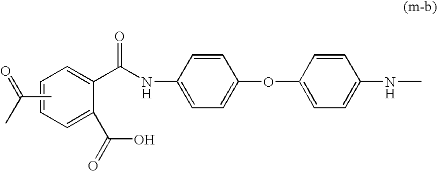

wherein the attachment of the two amide groups to the aromatic ring as shown in (m-b) will be understood to represent the 1,3 and the 1,4 polyamide-amic acid configurations; and

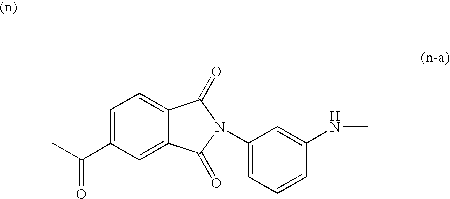

and/or the corresponding amide-amic acid containing recurring unit:

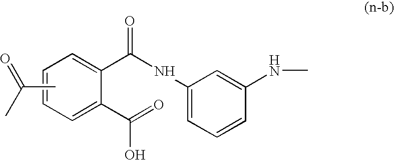

wherein the attachment of the two amide groups to the aromatic ring as shown in (n-b) will be understood to represent the 1,3 and the 1,4 polyamide-amic acid configurations.

Very preferably, the aromatic polyamide-imide comprises more than 90 wt. % of recurring units (R4). Still more preferably, it contains no recurring unit other than recurring units (R4). Polymers commercialized by Solvay Advanced Polymers as TORLON® polyamide-imides comply with this criterion.

The aromatic polyamide-imide can be notably manufactured by a process including the polycondensation reaction between at least one acid monomer chosen from trimellitic anhydride and trimellitic anhydride monoacid halides and at least one comonomer chosen from diamines and diisocyanates.

Among the trimellitic anhydride monoacid halides, trimellitic anhydride monoacid chloride is preferred.

The comonomer comprises preferably at least one aromatic ring. Besides, it comprises preferably at most two aromatic rings. More preferably, the comonomer is a diamine. Still more preferably, the diamine is chosen from the group consisting of 4,4′-diaminodiphenylmethane, 4,4′-diaminodiphenylether, m-phenylenediamine and mixtures thereof.

Polymer composition (C2) comprises advantageously more than 25 wt. % of polymer (P3).

In a certain embodiment of the present invention, a preferred polymer composition (C2) is one comprising more than 50 wt. % of polymer (P3) [polymer composition (C2*)]. Polymer composition (C2*) comprises preferably more than 80 wt. %, more preferably more than 95 wt. % of polymer (P3). Still more preferably, polymer composition (C2*) consists essentially of, or even consists of, polymer (P3).

In another embodiment of the present invention, a preferred polymer composition (C2) is one further comprising, in addition to polymer (P3), at least one filler [polymer composition (C2**)].

Non limitative examples of suitable fillers include flake, spherical and fibrous particulate reinforcement fillers and nucleating agents such as talc, mica, titanium dioxide, potassium titanate, silica, kaolin, chalk, alumina, mineral fillers, and the like. Other suitable fillers include notably glass fiber, carbon fiber, graphite fiber, fibers formed of silicon carbide, alumina, titania, boron and the like, and may include mixtures comprising two or more such fibers.

Polymer composition (C2**) comprises preferably at least one fibrous filler.

The weight amount of filler comprised in polymer composition (C2**) is advantageously at least 5 wt. %, and preferably at least 20 wt. % based on the total weight of the polymer composition. Besides, it is advantageously at most 40 wt. %, and preferably at most 20 wt. % based on the total weight of the polymer composition.

Polymer composition (C2**) comprises preferably more than 50 wt. % of polymer (P3). Still more preferably, polymer composition (C2**) comprises preferably more than 75 wt. % of polymer (P3).

Polymer composition (C2) is comprised in article (A) in an amount of advantageously at least 10 volume %, preferably at least 20 volume % and still more preferably at least 30 volume %, based on the total volume of the article.

Besides, polymer composition (C2) is comprised in article (A) in an amount of advantageously at most 70 volume %, preferably at most 50 volume % and still more preferably at most 40 volume %, based on the total volume of the article.

Besides, polymer composition (C2) is comprised in article (A) in an amount of advantageously at least 5 wt. %, based on the total weight of the article.

Besides, polymer composition (C2) is comprised in article (A) in an amount of advantageously at most 30 wt. %, based on the total weight of the article.

The thickness of overmolded polymer composition (C2) is not limited, but is preferably from 0.25 to 1.5 mm, including for example 0.3, 0.4, 0.5, 0.6, 0.7, 0.8, 0.9, 1.0, 1.1, 1.2, 1.3, and 1.4 mm. Very preferably, the thickness of overmolded polymer composition (C2) is above 0.5 mm. Still more preferably, the thickness of overmolded polymer composition (C2) is above 0.8 mm.

Polymer composition (C2) is comprised in article (A) in an amount of not exceeding advantageously 2 times, preferably one time, very preferably ½ time and still more preferably ¼ time the amount of polymer composition (C) in, article (A) (amounts in volume).

Another aspect of the invention relates to a process for producing the invention articles. As used herein, molding refers to the process of forming an invention high performance plastic in contacting relation to an insert. Preferred methods for molding the invention overmolded articles include, but are not limited to, injection molding, casting, extruding, compression molding, sintering, machining, or combinations thereof. Injection molding is especially preferred.

The molding process will be further understood with reference to the following non-limiting examples.

### Example 1

### Molding Polymer Composition (C) onto a Metal Component by Injection Molding

A metal component which is overmolded with a homopolymer the recurring units of which are recurring units

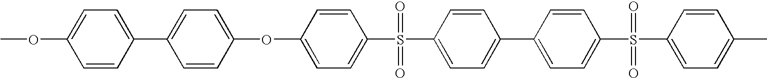

[homopolymer (H)] is produced. In order to produce the article, a metal component is heated at above 250° C. and inserted into a mold of an injection molding machine. The mold is designed so that the metal component remains fixed in place during injection of the high performance plastic. The metal insert is then injection molded using homopolymer (H). The injection molded homopolymer (H) almost completely covers the metal component, with only small fraction of the surface of the metal component exposed. The thickness of overmolded polymer (H) is about 1.0 mm.

### Example 2

### Molding Polymer Composition (C) onto a Metal Component by Heat and Pressure Followed by Machining

A sintered bronze is poured onto a substrate consisting of steel in a substantially uniform layer (from a macroscopic point of view), however exhibiting important local variations of thickness (at microscopic scale); then, it is bonded to the steel substrate by sintering (i.e. by the action of heat and pressure), to obtain a composite element insert.

A roll of homopolymer (H) film is positioned adjacent to the composite element and brought in contact with the sintered bronze layer of composite element. The film is then bonded to the sintered bronze coated metal substrate using heat and pressure. The bond is achieved notably by the flow of the film into the sintered bronze layer. High performance components are then shaped from the composite material.

1. An article (A) comprising at least one metal component (7) said metal component (M) being overmolded with at least one polymer composition (C) comprising at least one high glass transition temperature sulfone polymer (P) which more than 50 wt. % of recurring units are recurring units (R1): 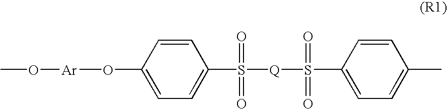
wherein Ar and Q, equal or different are divalent radicals comprising at least one aromatic ring.

2. The article according to claim 1, wherein Q is a group chosen among the following structures: 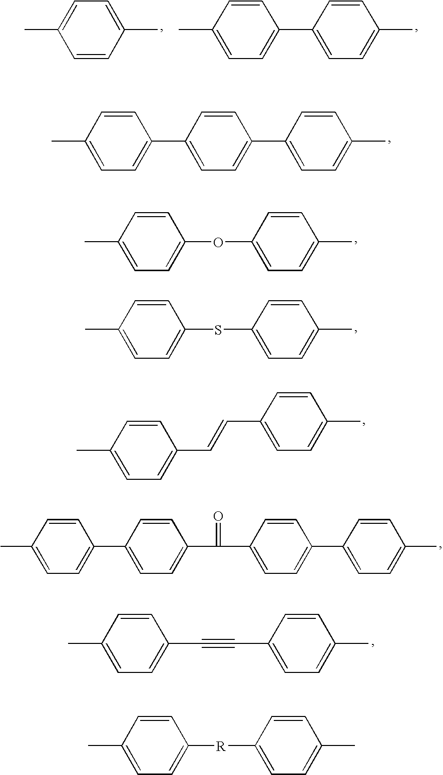
with R being 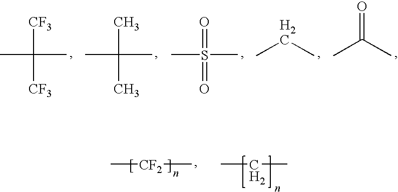
wherein n is an integer from 1 to 6, or an aliphatic divalent group, linear or branched, of up to 6 carbon atoms;
and mixtures thereof and
Ar is a group chosen among the following structures: 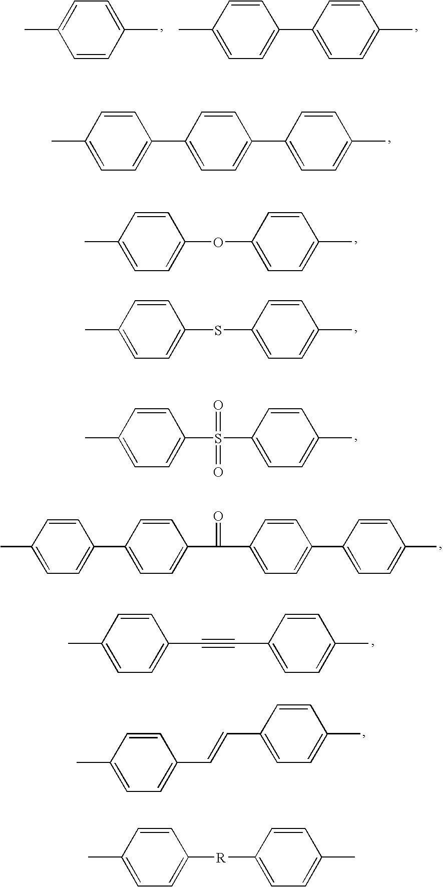
with R being: 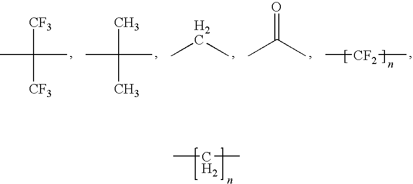
wherein is an integer from 1 to 6, or an aliphatic divalent group) linear or branched, of up to 6 carbon atoms;
and mixtures thereof.

3. The article according to claim 1, wherein the recurring units (R1) are chosen from 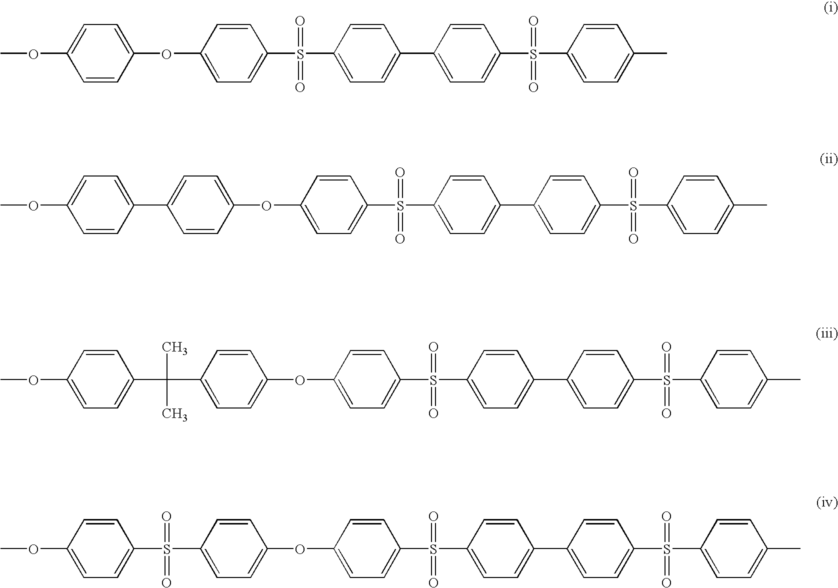
and mixtures therefrom.

4. The article according to claim 1, wherein the polymer (P) contains no recurring unit other than the recurring units (R1).

5. The article according to claim 1, wherein the polymer (P) contains no recurring unit other than the recurring units (R1), said recurring units (R1) being recurring units (ii)

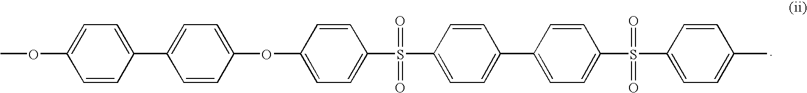

6. The article according to claim 1, wherein the polymer (P) contains no recurring unit other than the recurring units (R1), the said recurring units (R1) being a mixture of recurring units (iv): 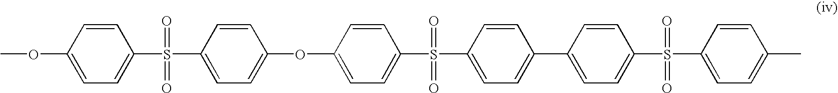
with recurring units of one or more formulae selected from the group consisting of recurring units (i), (ii) and (iii):

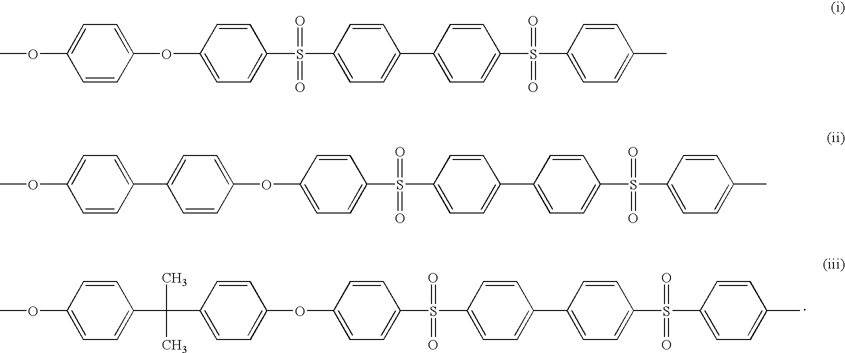

7. The article according to claim 1, wherein the polymer composition (C) comprises more than 50 wt. % of the polymer (P).

8. The article according to claim 1, wherein the polymer composition (C) comprises more than 95 wt. % of the polymer (P).

9. The article according to claim 1, wherein the polymer composition (C) consists essentially of the polymer (P).

10. The article according to claim 1, wherein the volume fraction of the polymer composition (C) is from 20 to 65% based on total volume of the article (A).

11. The article according to claim 1, wherein the weight fraction of the polymer composition (C) is from 5 to 30% based on total weight of article (A).

12. The article according to claim 1, whereon the thickness of the overmolded polisher composition (C) is from 0.25 to 1.5 mm.

13. The article according to claim 1, which, in essence and from a functional perspective, is a single component which allows for the “drop-in” replacement of a multi-component article.

14. The article according to claim 1, wherein the metal component (M) is chosen from steel, iron, titanium, copper, tin, aluminum, gold, silver, and mixtures thereof.

15. The article according to claim 1, wherein the overmolded metal component (M) is approximately the same shape and dimension as the metal component (M) taken alone, before it is overmolded.

16. The article according to claim 1, wherein the metal component (M) is partly overmolded with the polymer composition (C).

17. The article according to claim 16, wherein the metal component (M) is also partly overmolded with at least one polymer composition (C2) comprising at least one high-temperature polymer (P3) different from the polymer (P).

18. The article according to claim 17, wherein the polymer (P3) is an aromatic polyamide-imide.

19. The article according to claim 17, wherein the polymer composition (C2) consists essentially of the polymer (P3).

20. A method for producing an article according to claim 1, wherein the polymer composition (C) is applied onto a surface of the metal component (M).

21. The method according to claim 1, wherein the polymer composition (C) is injection molded, casted, extruded, compression molded, sintered, machined, or a combination thereof, onto a surface of the metal component (M).
